(19) United States
(12) Patent Application Publication
(10) Pub. No.: US 2013/0097110 A1
(43) Pub. Date: Apr. 18, 2013

(54) SYSTEM FOR RECOMMENDING ADVICE BASED ON USER PSYCHOLOGY INDEX

(71) Applicant: Oh Byung Kwon, Seongnam-si (KR)

(72) Inventor: Oh Byung Kwon, Seongnam-si (KR)

(73) Assignee: UNIVERSITY-INDUSTRY COOPERATION GROUP OF KYUNG-HEE, GUEPMGGO-DO (KR)

(21) Appl. No.: 13/807,982

(22) PCT Filed: Sep. 20, 2011
(86) PCT No.: PCT/KR11/06952

§ 371 Date: Jan. 2, 2013

(30) Foreign Application Priority Data
May 30, 2011 (KR) 10-2011-0051537

(51) Int. Cl. G06N 5/02

(52) U.S. Cl. CPC G06N 5/02
USPC 706/50

(57) ABSTRACT

The present invention relates to a system for determining a user psychology index based on user situation information and user profile information and recommending an advice needed for a user according to the determined psychology index.

The advice recommendation system according to the present invention determines a user psychology index based on user situation information and user profile information, and the advice recommendation system may correctly diagnose a psychological state of a user and recommend suitable advice for overcoming the diagnosed psychological state. In addition, the advice recommendation system according to the present invention periodically collects user situation information and determines personalized tendency of a user toward the collected user situation information, and thus the advice recommendation system may correctly recommend personalized advice to the user.

### TECHNICAL FIELD

The present invention relates to a system for determining a user psychology index based on user situation information and user profile information and recommending an advice needed for a user according to the determined user psychology index.

### BACKGROUND ART

A ubiquitous environment refers to an information communication environment in which a user can freely connect to a network regardless of a place without considering the network or a computer. Ubiquitous is a Latin word meaning ‘existing everywhere at the same time’, and it refers to an environment in which a user can freely connect to the network regardless of time and space. In the ubiquitous environment, a user can utilize information technologies at home or in a car, or even at the summit of a mountain. Since the number of computer users connected to the network increases, the scale and range of the information technology industry grow accordingly.

A situation recognition service is one of the fields that are extensively studied and developed in such a ubiquitous environment. The situation recognition service presents a technical means for expressing all situations in the real world and enables human-oriented autonomous services based on the technical means by applying intelligent techniques such as situation recognition, extraction of features of a situation, learning, inference and the like. The situation recognition service realizes a variety of services in association with smart phones that are widely distributed recently, and it is a method useful in providing personalized and automated services.

As a negative effect of the recent technical advancement, users feel stress, depression, anger and fatigue more considerably, and various counseling methods for overcoming or improving those feelings are developed recently. However, the conventional counseling methods are inconvenient in that a user should visit a clinic by himself or herself or search for advice open to the public and find a method suitable for the user to overcome the stress, depression, anger and fatigue. Furthermore, it is difficult to objectively determine a user's emotional state among the stress, depression, anger and fatigue in the conventional counseling methods. Although the user objectively determines the user's emotional state of the user, a degree of the emotion is difficult to correctly determine, and thus it is difficult to find an adequate improvement method. Furthermore, the conventional counseling methods entail a problem in that it is difficult to distinguish stress, depression, anger or fatigue that a user feels in real-time in the current situation of the user. Furthermore, it is difficult to immediately improve or overcome the stress, depression, anger or fatigue of the user by in real-time providing a method for improving or overcoming the stress, depression, anger and fatigue that the user currently feels. In addition, the conventional counseling methods involves a problem in that although an advice that can be selected by a user or has a high preference varies depending on a user situation information and user profile information, the advice is randomly recommended to the user regardless of the user situation information and the user profile information, thus leading to a decrease in relevancy and effectiveness of the advice.

### DISCLOSURE OF INVENTION

### Technical Problem

The ubiquitous environment and the smart phone environment may effectively provide users with personalized services, and an advice recommendation system is required which can provide an advice suitable for a user in real-time according to a user psychology index such as stress, depression, anger or fatigue that the user feels, in order to ensure mental richness and stability of the user based on user situation information and user profile information.

The present invention has been made to solve the above-mentioned problems associated with the prior art, and it is an object of the present invention to provide an advice recommendation system that determines a user psychology index in real-time and recommends a personalized advice to a user according to the determined user psychology index.

Another object of the present invention is to provide a system for extracting an advice that can be selected by a user or has a high preference according to user situation information and user profile information and recommending the extracted advice to the user.

Still another object of the present invention is to provide a system for determining a user psychology index in real-time based on user situation information and user profile information and recommending an advice corresponding to the determined psychology index.

### Technical Solution

To achieve the above objects, in one aspect, the present invention provides an advice recommendation system including:

a user information collection unit for collecting user situation information and user profile information;

a user information management unit for comparing the collected user situation information with user situation information previously stored in a user information database, and if the collected user situation information is different from the previously stored user situation information, calculating a user psychology index corresponding to the collected user situation information from an answer to a questionnaire inputted by a user, the collected user situation information and the user profile information, and storing the calculated user psychology index in the user information database;

an advice determination unit for, if new user situation information is collected, searching for a user psychology index matching to the newly collected user situation information from the user information database and determining whether a unit advice level of the searched user psychology index corresponds to a discard level or an advice level; and

an advice providing unit for searching for an advice corresponding to the determined unit advice level, the user profile information and the newly collected user situation information from an advice database and outputting the searched advice to the user.

Here, the user situation information includes user position information obtained from a GPS, user environment information such as illuminance, humidity, noise and temperature received from environment detection sensors, user scheduling information, information on the user's activity amount received from an activity amount detection sensor, user biomedical information received from a biomedical signal detection sensor, and current time information. Meanwhile, the user profile information includes a job, an age, a residential address, a sex, a medical history, a marriage status, education and an income level of the user inputted by the user.

More specifically, the user information management unit includes: a comparison and determination unit for comparing the collected user situation information with the user situation information previously stored in the user information database and determining whether or not the collected user situation information is stored in the user information database; a questionnaire providing unit for, if the collected user situation information is not stored in the user information database in advance, providing a questionnaire inquiring index factors which are obtained by converting an absolute magnitude of each user situation information item configuring the collected user situation information into a subjective magnitude that the user actually feels, and receiving an answer to the questionnaire from the user; and a psychology index calculation unit for calculating a user psychology index corresponding to the collected user situation information through a regression model equation which defines a correlation between independent factors and dependent factors using the user situation information, the user profile information and the index factors as independent factors and using the user psychology index as a dependent factor, and storing the calculated user psychology index in the user information database.

Preferably, the advice recommendation system further includes an update control unit for updating the user psychology index corresponding to the user situation information stored in the user information database, periodically or each time the user profile information is changed.

Here, the user psychology index includes a depression index, an anger index, a stress index and a mental fatigue index.

More specifically, the advice providing unit includes: a level determination unit for determining whether or not the user psychology index calculated from the newly collected user situation information is the advice level;

an advice provision determination unit for, if the user psychology index is the advice level as a result of the determination, determining whether or not to provide the advice by transmitting an advice inquiry message to the user and receiving an advice response message from the user; and an advice search unit for, if it is determined to provide the advice by the advice provision determination unit, searching for an advice corresponding to the newly collected user situation information from the advice database and outputting the searched advice to the user.

In an embodiment, the advice search unit includes: a meta-information comparison unit for comparing meta-information or index words of advices which is stored in the advice database and matches to the determined unit advice level with the user profile information or the newly collected user situation information; an advice extraction unit for extracting an advice including meta-information or index words corresponding to the user profile information or the newly collected user situation information from the advice database based on a result of the comparison; a priority calculation unit for calculating a priority of the extracted advice in the order of an advice having meta-information or index words corresponding to the user situation information or the user profile information having a high weighting factor or in the order of the number of meta-information or index words corresponding to the user situation information or the user profile information, based on the weighting factor of the user profile information or the newly collected user situation information and the number of matched meta-information or index words; and an advice output control unit for outputting the advice to the user according to the calculated priority of the extracted advice.

According to another embodiment, the advice search unit includes: a meta-information comparison unit for comparing meta-information or index words of the advice stored in the advice database and matching to the determined unit advice level with the user profile information or the newly collected user situation information; an advice extraction unit for extracting an advice including meta-information or index words corresponding to the user profile information or the newly collected user situation information from the advice database based on a result of the comparison; a priority calculation unit for calculating a priority of the extracted advice depending on similarity between a matching vector created from weighting factors of the user profile information and the newly collected user situation information and an advice vector created from the meta-information or the index words of the extracted advice, putting the user profile information and the newly collected user situation information on different axes; and an advice output control unit for outputting the advice to the user according to the calculated priority of the extracted advice.

In another aspect, an advice recommendation system includes: a user information management unit for comparing inputted user situation information with user situation information previously stored in a user information database, and if the inputted user situation information is different from the previously stored user situation information, calculating a user psychology index corresponding to the inputted user situation information from an answer to a questionnaire inputted by a user, the inputted user situation information and the user profile information, and storing the calculated user psychology index in the user information database; an advice determination unit for, if new user situation information is inputted, searching for a user psychology index matching to the newly inputted user situation information from the user information database and determining whether a unit advice level of the searched user psychology index corresponds to a discard level or an advice level; and an advice providing unit for searching for an advice corresponding to the determined unit advice level, the user profile information and the newly inputted user situation information from an advice database and outputting the searched advice to the user.

### Advantageous Effects

The advice recommendation system in accordance with the present invention has the following various advantageous effects compared with a conventional advice recommendation system.

First, the advice recommendation system according to the present invention determines a user psychology index based on user situation information and user profile information, and the advice recommendation system may correctly diagnose a psychological state of a user and recommend suitable advice for overcoming the diagnosed psychological state.

Second, the advice recommendation system according to the present invention periodically collects user situation information and determines personalized tendency of a user toward the collected user situation information, and thus the advice recommendation system may correctly recommend personalized advice to the user.

Third, the advice recommendation system according to the present invention extracts advice that can be selected by a user or has a high preference based on user situation information and user profile information, and thus the advice recommendation system may recommend personalized advice to the user.

Fourth, the advice recommendation system according to the present invention calculates and stores a user psychology index according to user situation information collected through a questionnaire for analyzing tendency of a user when the user situation information is collected, and thus the user can easily use the advice recommendation system without a complex procedure for being recommended with advice. In addition, the user psychology index corresponding to the user situation information is updated periodically or when user profile information is changed, and thus advice correctly reflecting user's tendency can be recommended.

### BRIEF DESCRIPTION OF THE DRAWINGS

FIG. 1 is a functional block diagram showing an advice recommendation system according to an embodiment of the present invention.

FIGS. 2 and 3 are functional block diagrams showing an advice recommendation system according to another embodiment of the present invention.

FIG. 4 is a functional block diagram showing a user information management unit according to an embodiment of the present invention.

FIG. 5 is a functional block diagram showing an advice providing unit 50 according to an embodiment of the present invention.

FIG. 6 is a functional block diagram showing an advice search unit according to an embodiment of the present invention in further detail.

FIG. 7 is a flowchart illustrating a method of calculating a user psychology index according to user situation information and storing the user psychology index in a user information database in an advice recommendation system according to the present invention.

FIG. 8 is a flowchart illustrating a method of recommending an advice to a user according to user situation information in an advice recommendation system according to the present invention.

FIG. 9 is a flowchart illustrating the step of extracting an advice in further detail.

FIG. 10 is a view showing an example of an advice vector.

FIG. 11 is a view showing an example of user profile information inputted by a user.

FIG. 12 is a view showing an example of index factors inputted from an answer of a questionnaire.

### BEST MODE FOR CARRYING OUT THE INVENTION

An advice recommending system according to the present invention will be described hereinafter in more detail with reference to the accompanying drawings.

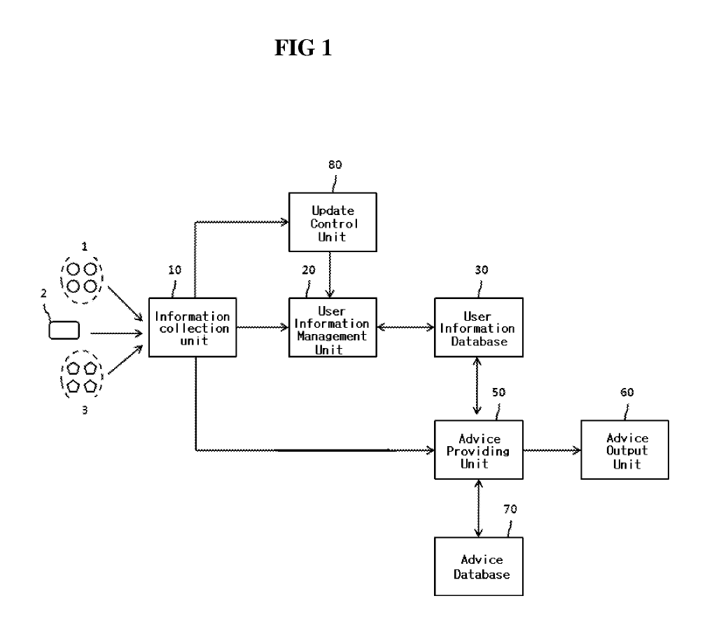

FIG. 1 is a functional block diagram showing an advice recommendation system according to an embodiment of the present invention.

Referring to FIG. 1, an information collection unit collects user situation information from environment detection sensors 1, a user terminal or a biomedical signal detection sensor 3, collects user profile information in the process registering a user in the advice recommendation system, or periodically collects the user profile information. Here, the user situation information is information on dynamically changing situations of a user such as information on an environment surrounding the user, current position, current weather, schedule of the user and biomedical information of the user, and the user profile information is information for identifying a user or expressing features of the user, such as the name, age, sex, marriage status and residential address of the user.

A method of collecting the user situation information will be described hereinafter in detail. The information collection unit 10 collects user environment information from environment sensors 1 when a user is positioned in a specific space, e.g., positioned in a space where the environment sensors 1 for sensing environment information such as humidity, temperature, saturation, noise or the like are installed, collects user schedule information stored in the user terminal 2, collects current position of the user through a GPS module provided in the user terminal 2, or collects biomedical information such as information on the amount of activity such as consumed calorie, blood pressure, body temperature, pulse and the like of the user from the biomedical signal detection sensor installed in the user terminal 2 or in some body parts of the user.

A method of collecting the user profile information will be described hereinafter in detail. When a user registers into the advice recommendation system so as to be provided with advice recommendation services, the information collection unit 10 transmits an interface screen to the user terminal 2 to input the user profile information by the user under the control of a user information management unit 20 and collects the user profile information inputted by the user through the user terminal 2.

For example, the information collection unit 10 collects the user situation information or the user profile information from the environment sensors, the user terminal, and the biomedical signal detection sensor under the control of the user information management unit 20 when a collection control command is received from the user information management unit 20. For another example, the information collection unit 10 collects the user situation information in real-time when new user situation information on a user is generated without control of the user information management unit 20, e.g., when the user is positioned in a specific space where the environment sensors are installed or when the biomedical signal of the user is changed.

The user information management unit 20 compares the collected user situation information with user situation information previously stored in a user information database 30. If the collected user situation information is not stored in the user information database 30, the user information management unit 20 calculates a user psychology index corresponding to the collected user situation information from an answer to a questionnaire about the collected user situation information inputted by the user, the collected user situation information and user situation information, and stores the user psychology index in the user information database 30. The user information database 30 stores the user situation information collected through the user information collection unit 10, the user profile information and information on the user psychology index calculated from the collected user situation information. Here, the user psychology index is an index related to mental richness and stability of the user and includes a stress index, a depression index, an anger index and a mental fatigue index, and various psychology indexes can be used depending on the application fields of the present invention, and this is within the scope of the present invention.

If new user situation information is collected through the information collection unit 10, an advice providing unit 50 searches for a user psychology index matching to the newly collected user situation information from the user information database 30, determines whether a unit advice level of the searched user psychology index corresponds to a discard level or an advice level, searches for advice corresponding to the determined unit advice level from an advice database 70, extracts advice having index words or meta-information the same as that of the user profile information or the newly collected user situation information among the searched advice, and provides the extracted advice to an advice output unit 60. The advice providing unit 50 searches for a single or a plurality of user psychology indexes matching to the newly collected user situation information and determines whether the user psychology index corresponds to the discard level or the advice level. Here, the advice level is divided into unit advice levels, and for example, the advice level is classified into high, intermediate and low or divided by the unit of one from one to ten. The advice output unit 60 is a device for outputting the extracted advice, and a display, a speaker or the like can be used as the advice output unit 60. A variety of devices that can output the advice in voices or on the display can be used depending on the application fields of the present invention.

Meanwhile, an update control unit 80 updates the user psychology index corresponding to the user situation information stored in the user information database 30 through the user information management unit 20, periodically or when the user profile information is changed. If the user profile information is changed or a long time has passed, relative magnitude of noise, temperature and illuminance that the user subjectively feels can be different from the absolute magnitude of the user situation information such as noise, temperature, illuminance and the like, and thus the update control unit 80 updates the user psychology index corresponding to the user situation information previously stored in the user information database 30 periodically or when the user profile information is changed and store the updated user psychology index in the user information database 30 through the user information management unit 20.

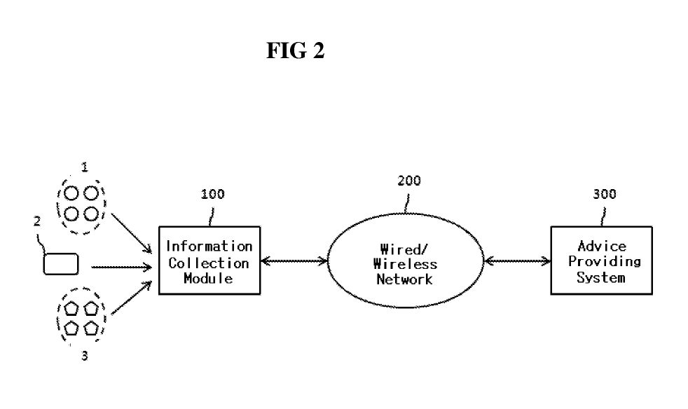

FIGS. 2 and 3 are functional block diagrams showing an advice recommendation system according to another embodiment of the present invention.

Referring to FIG. 2, an information collection module 100 is installed in the user terminal 2 possessed by the user or in a specific space where the user is positioned and collects user situation information from the environment sensors 1, the user terminal 2 and the biomedical signal detection sensor 3. The information collection module 100 is connected to an advice providing system 300 through a wired/wireless network 200 and transmits the collected user situation information to the advice providing system 300 through the network 200. The user situation information transmitted from the information collection module 100 to the advice providing system 300 includes a user identifier for identifying a user, and a serial number of the user terminal can be used as the user identifier.

When the user situation information is received, the advice providing system 300 extracts advice to be recommended to the user from the received user situation information, the user profile information and the user psychology index and transmits the extracted advice to the user terminal 1 through the network.

The advice providing system will be described hereinafter in further detail with reference to FIG. 3. The functions and operations of a user information management unit 310, a user information database 320, an advice providing unit 340, an advice output unit 350, an advice database 360 and an update control unit 370 of the advice providing system shown in FIG. 3 are the same as those of the user information management unit 20, the user information database 30, the advice providing unit 50, the advice output unit 60, the advice database 70 and the update control unit 80 of the advice recommendation system shown in FIG. 1, and the advice providing system shown in FIG. 3 is different from the advice recommendation system shown in FIG. 1 in that the information collection module 100 is not integrated in the advice recommendation system, and thus detailed descriptions thereof will be omitted.

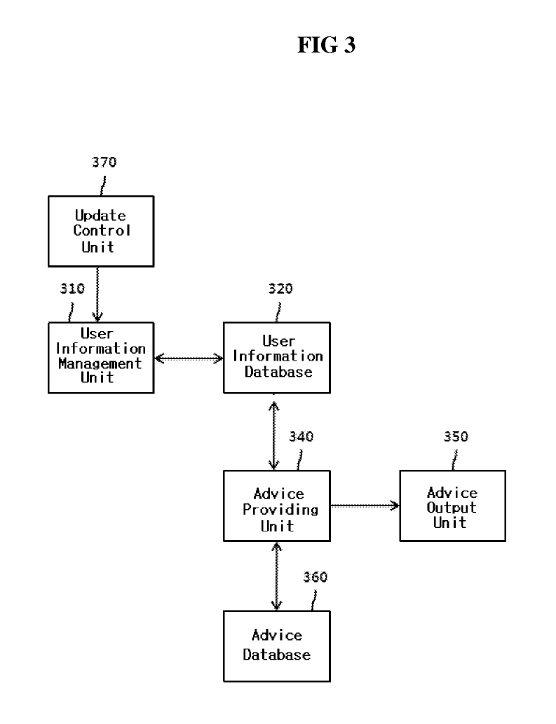

FIG. 4 is a functional block diagram showing a user information management unit according to an embodiment of the present invention.

The user information management unit will be described hereinafter in further detail with reference to FIG. 4. When the information collection unit 10 collects user situation information, a comparison and determination unit 21 determines whether or not the collected user situation information is the user situation information previously stored in the user information database 30 by comparing the collected user situation information with the user situation information previously stored in the user information database 30.

If the collected user situation information is not stored in the user information database 30 as a result of the determination of the information collection unit 10, a questionnaire inquiring a subjective magnitude of the user situation information with respect to the absolute magnitude of the user situation information is created and provided to the user through a questionnaire providing unit 23, and an answer to the questionnaire is received from the user. That is, the questionnaire providing unit 23 provides a questionnaire inquiring index factors which are obtained by converting an absolute magnitude of each user situation information item configuring the collected user situation information into a subjective magnitude that the user actually feels, and receives an answer to the questionnaire from the user. As an example of the questionnaire provided to the user through the questionnaire providing unit 23, a temperature that the user subjectively feels can be classified into “very cold, cold, moderate, warm and very warm” and inquired to the user. For example, since a temperature felt by each user at 11 degrees above zero is different from user to user, a user psychology index can be correctly measured using information on the subjective magnitude that the user feels at the absolute magnitude of each user situation information item. Preferably, a subjective magnitude that the user actually feels for the absolute magnitude of each user situation information item is converted into index factors (index factor of ‘very cold’: 0, index factor of ‘cold’: 1, index factor of ‘moderate’: 2, index factor of ‘warm’: 3 and index factor of ‘very warm’: 4), and the user answers the questionnaire.

A psychology index calculation unit 25 calculates a user psychology index corresponding to the collected user situation information through a regression model equation which defines a correlation between independent factors and dependent factors using the collected user situation information, the user profile information stored in the user information database 30 and the calculated index factors as independent factors and the user psychology index as a dependent factor, and the psychology index calculation unit 25 stores the calculated user psychology index in the user information database 30. Here, the regression model equation is an equation for studying and defining various items contributing to the stress index, the depression index, the anger index and the mental fatigue index and defining a relation between each independent variable and a dependent variable, i.e., a correlation which shows how much the independent variable contributes to the dependent variable, using the stress index, the depression index, the anger index and the mental fatigue index as dependent variables and various items contributing to each user psychology index as independent variables. The regression model equation corresponding to each user psychology index is stored in a separate regression model equation database (not shown) or in the user information database 30.

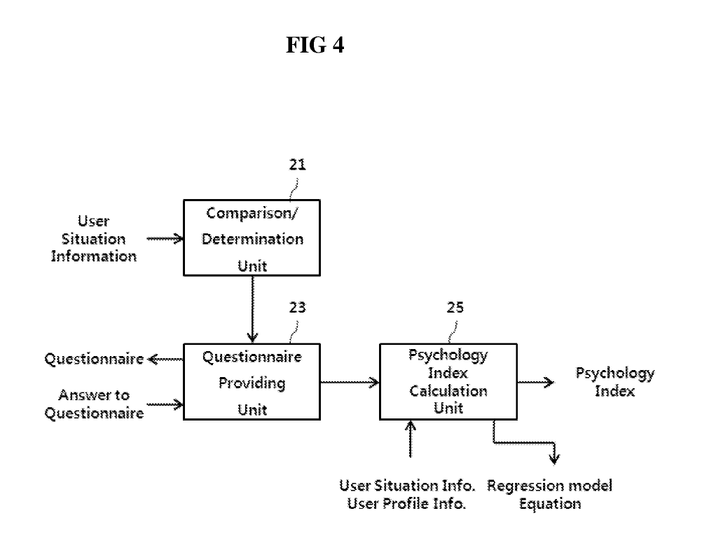

FIG. 5 is a functional block diagram showing an advice providing unit 50 according to an embodiment of the present invention.

The advice providing unit 50 will be described hereinafter in further detail with reference to FIG. 5. When new user situation information is inputted through the information collection unit 10, a level determination unit searches for a user psychology index matching to the inputted user situation information from the user information database 30 and determines whether the searched user psychology index corresponds to a discard level which does not need advice for the user or an advice level which needs advice for the user. In addition, the level determination unit 51 determines a degree of the level among unit advice levels based on the magnitude of the user psychology index.

If the magnitude of the user psychology index corresponds to the advice level based on a result of the determination of the level determination unit 51, an advice provision determination unit 53 creates and transmits an advice inquiry message inquiring whether or not to provide the user with the advice to the user and receives an advice response message requesting the advice from the user. When the advice provision determination unit 53 receives the advice response message, an advice search unit 55 searches for advice to be recommended to the user by comparing meta-information or index words of the advice matching to the determined unit advice level and stored in the advice database 70 with the newly collected user situation information or the user profile information and outputs the searched advice to the advice output unit 60.

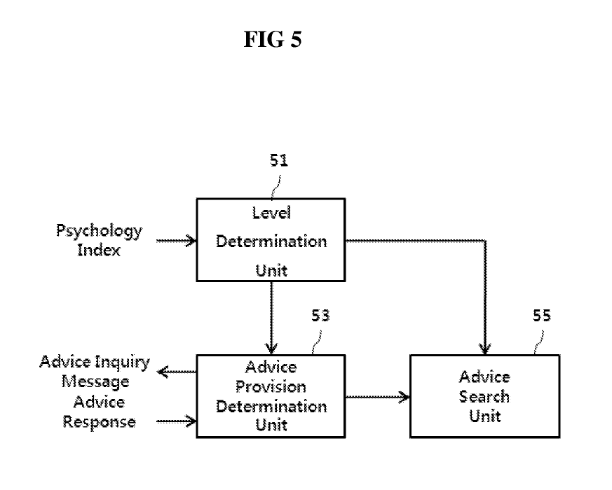

FIG. 6 is a functional block diagram showing an advice search unit according to an embodiment of the present invention in further detail.

The advice search unit will be described hereinafter in further detail with reference to FIG. 6. A meta-information comparison unit 111 compares the meta-information or the index words of the advice matching to the determined unit advice level and stored in the advice database 70 with the user situation information or the user profile information, and an advice extraction unit 113 extracts advice having meta-information or index words corresponding to the user situation information or the user profile information among the advice stored in the advice database 70, based on a result of the comparison of the meta-information comparison unit 111. A priority calculation unit 115 calculates a priority of the extracted advice in the order of an advice having a high weighting factor or in the order of the number of meta-information or index words corresponding to the user situation information or the user profile information, based on the weighting factor and the number of matched meta-information or index words of the user situation information or the user profile information. An advice output control unit 117 controls to output the extracted advice to the advice output unit 60 according to the priority of the advice calculated by the priority calculation unit 115.

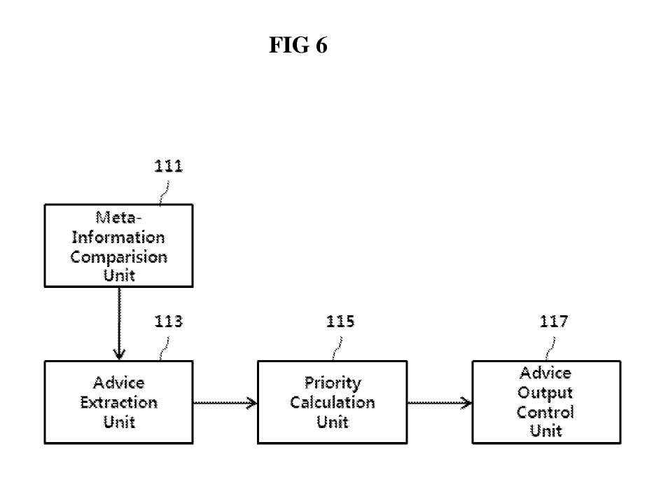

FIG. 7 is a flowchart illustrating a method of calculating a user psychology index according to user situation information and storing the user psychology index in a user information database in an advice recommendation system according to the present invention.

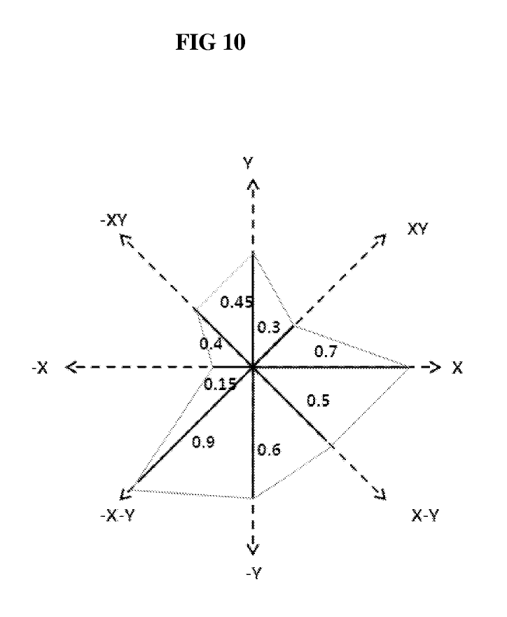

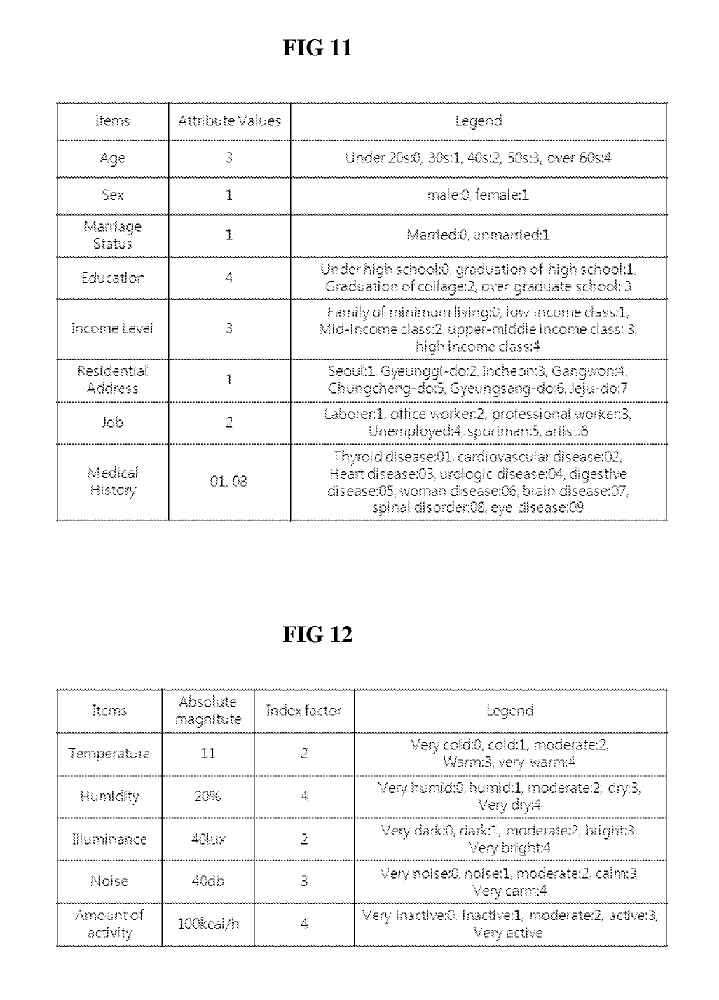

The method of calculating a user psychology index will be described hereinafter in further detail with reference to FIG. 7. User profile information inputted when a user registers in the advice recommendation system or inputted by the user is collected (S100), and user situation information is collected from the environment sensors, the user terminal and the biomedical signal detection sensor (S110). FIG. 11 is a view showing an example of the user profile information inputted by the user, and information such as the age, sex, marriage status, education, income level, residential address, job and medical history of the user is inputted by the user through the user terminal as attribute values of the legend. When the user situation information is collected, it is determined whether or not the collected user situation information is the same as user situation information stored in the user information database by comparing the collected user situation information with the user situation information stored in the user information database (S120). If the collected user situation information is not stored in the user information database in advance, a questionnaire inquiring index factors, which are obtained by converting an absolute magnitude of each user situation information item configuring the collected user situation information into a subjective magnitude that the user actually feels, is provided, and an answer to the questionnaire is received from the user (S130). FIG. 12 shows an example of an answer to the questionnaire, and a subjective magnitude that the user actually feels for an absolute magnitude of the user situation information such as temperature, humidity, illuminance, noise, amount of activity or the like is converted into index factors of the legend and inputted by the user through the user terminal. A user psychology index is calculated from the regression model equation using the collecteduser situation information, the user profile information and the index factors as independent variables and a stress index, a depression index, an anger index and a mental fatigue index as dependent variables (S140), and the calculated user psychology index is stored in the user information database (S150).

For example, the user psychology indexes of the stress index, the depression index, the anger index and the mental fatigue index are calculated from the regression model equations defined as equations 1 to 4, and the user psychology indexes can be calculated using various regression model equations depending on the application fields of the present invention, and this is within the scope of the present invention.

Stress index=0.42×Subjective magnitude of noise+0.31×Subjective magnitude of humidity+0.56×Subjective magnitude of temperature+1.223 [Equation 1]

Depression index=0.38×Subjective magnitude of noise−0.16×Amount of activity+0.26×Subjective magnitude of illuminance+0.34×Marriage status (Married: 0, Unmarried: 1)+0.07×Education [Equation 2]

Anger index=0.23×Biomedical signal+0.16×Subjective magnitude of noise+0.15×Income level+0.17×Education [Equation 3]

Mental fatigue index=0.18×Amount of activity+0.14×Biomedical signal+0.24×Subjective magnitude of noise+0.24×Subjective magnitude of temperature [Equation 4]

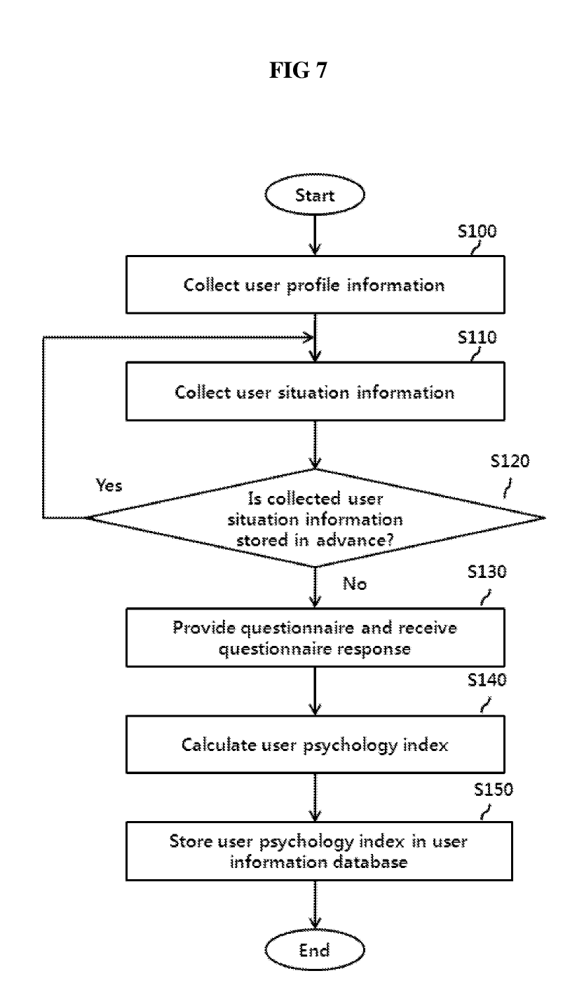

FIG. 8 is a flowchart illustrating a method of recommending an advice to a user according to user situation information in an advice recommendation system according to the present invention.

The method of recommending an advice will be described hereinafter in further detail with reference to FIG. 8, if user situation information is inputted (S210), a user psychology index matching to the inputted user situation information and stored in the user information database is searched based on the inputted user situation information, and it is determined whether the searched user psychology index corresponds to a discard level or an advice level (S220). If the searched user psychology index is an advice level as a result of the determination, it is determined whether or not an advice response message requesting advice is received from the user (S230). If the advice response message is received, advice to be recommended to the user is searched by comparing the meta-information or the index words of the advice stored in the advice database and matching to a unit advice level with the user situation information and the user profile information (S240), and the searched advice is outputted to the user (S250).

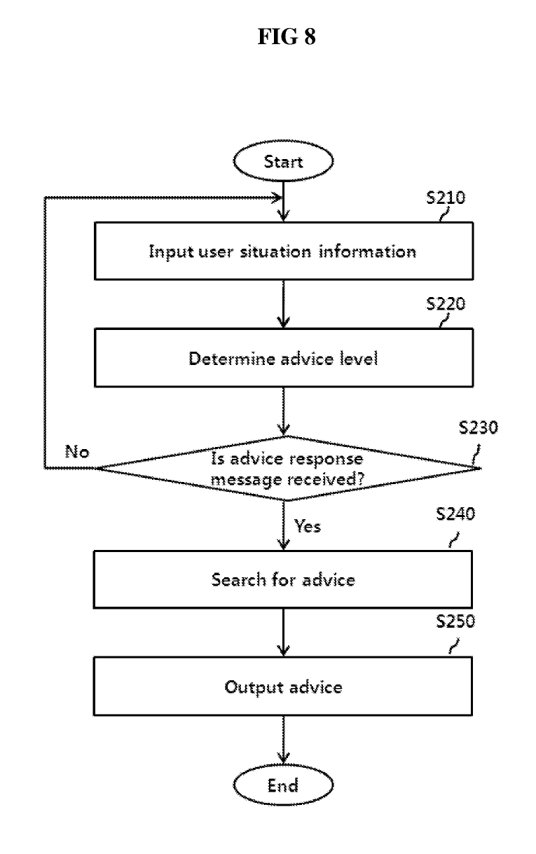

FIG. 9 is a flowchart illustrating the step of extracting an advice in further detail. The step of extracting an advice will be described hereinafter in further detail with reference to FIG. 9. The meta-information or the index words of the advice matching to a unit advice level and stored in the advice database is compared with the user situation information or the user profile information (S241), and advice having meta-information or index words corresponding to the user situation information or the user profile information is searched among the advice stored in the advice database based on a result of the comparison (S243). Then, a priority of the searched advice is calculated in the order of an advice having meta-information or index words corresponding to the user situation information or the user profile information having a high weighting factor or in the order of the number of meta-information or index words corresponding to the user situation information or the user profile information, based on the weighting factor and the number of matched meta-information or index words of the user situation information or the user profile information (S245). The searched advice is outputted according to the calculated priority of the advice.

An example of calculating a priority of the searched advice will be described hereinafter in further detail. The priority of the searched advice is calculated in the order of an advice having meta-information or index words corresponding to the user situation information or the user profile information having a high weighting factor or in the order of the number of meta-information or index words corresponding to the user situation information or the user profile information, based on a weighting factor applied to each of the user profile information and newly collected user situation information and the number of meta-information or index words of advice stored in the advice database and matching to the user profile information or the newly collected user situation information. Here, the weighting factor can be determined by an operator of the advice recommendation system or the user himself or herself.

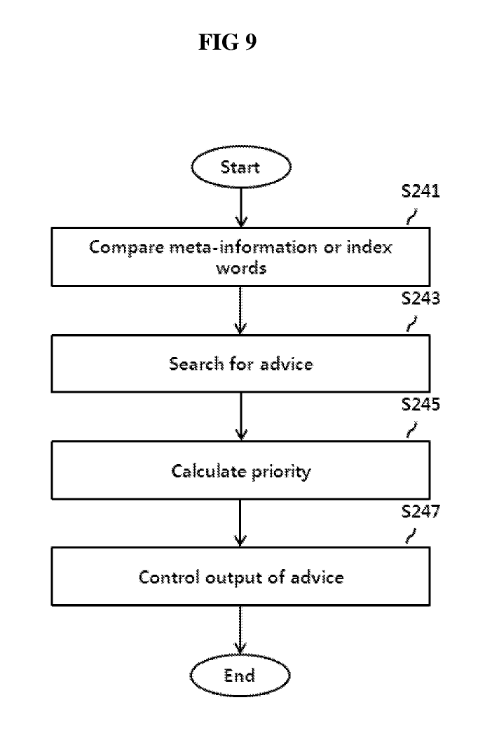

Describing another example of calculating a priority of the searched advice in further detail with reference to FIG. 10, the user profile information and the newly collected user situation information are put on different axes (X, XY, −XY, −X, −X−Y, −Y, X−Y), and a priority of the searched advice is calculated depending on similarity between a matching vector created from weighting factors of the user profile information and the newly collected user situation information and an advice vector created from the meta-information or the index words of the searched advice. For example, putting the user profile information and the user situation information on different axes, a priority of an advice having an advice vector similar to a matching vector created from weighting factors (0.7, 0.3, 0.45, 0.4, 0.15, 0.9, 0.6 and 0.5) of the user profile information or the user situation information is determined based on the similarity between the matching vector and the advice vector. Here, the similarity can be calculated from a size of an area where a figure formed by the matching vector is matched to a figure formed by the advice vector.

Here, the priority of the searched advice is calculated based on the user situation information and the user profile information. For example, if the user is determined as a male according to the user profile, advice corresponding to female is excluded, and if the age of the user is twenties, only the advice corresponding to twenties is searched. In addition, advice related to a position near the user is selected based on the current position. Therefore, advice easy to use and effective for the user can be recommended in real-time.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

1. An advice recommendation system comprising:
a user information collection unit for collecting user situation information and user profile information;
a user information management unit for comparing the collected user situation information with user situation information previously stored in a user information database, and if the collected user situation information is different from the previously stored user situation information, calculating a user psychology index corresponding to the collected user situation information from an answer to a questionnaire inputted by a user, the collected user situation information and the user profile information, and storing the calculated user psychology index in the user information database;
an advice determination unit for, if new user situation information is collected, searching for a user psychology index matching to the newly collected user situation information from the user information database and determining whether a unit advice level of the searched user psychology index corresponds to a discard level or an advice level; and
an advice providing unit for searching for an advice corresponding to the determined unit advice level, the user profile information and the newly collected user situation information from an advice database and outputting the searched advice to the user.

2. The advice recommendation system according to claim 1, wherein the user situation information comprises user position information obtained from a GPS, user environment information such as illuminance, humidity, noise and temperature received from environment detection sensors, user scheduling information, information on the user's activity amount received from an activity amount detection sensor, user biomedical information received from a biomedical signal detection sensor, and current time information.

3. The advice recommendation system according to claim 1, wherein the user profile information includes a job, an age, a residential address, a sex, a medical history, a marriage status, education and an income level of the user inputted by the user.

4. The advice recommendation system according to claim 2, wherein the user information management unit comprises:
a comparison and determination unit for comparing the collected user situation information with the user situation information previously stored in the user information database and determining whether or not the collected user situation information is stored in the user information database;
a questionnaire providing unit for, if the collected user situation information is not stored in the user information database in advance, providing a questionnaire inquiring index factors which are obtained by converting an absolute magnitude of each user situation information item configuring the collected user situation information into a subjective magnitude that the user actually feels, and receiving an answer to the questionnaire from the user; and
a psychology index calculation unit for calculating a user psychology index corresponding to the collected user situation information through a regression model equation which defines a correlation between independent factors and dependent factors using the user situation information, the user profile information and the index factors as independent factors and using the user psychology index as a dependent factor, and storing the calculated user psychology index in the user information database.

5. The advice recommendation system according to claim 4, wherein the advice recommendation system further comprises an update control unit for updating the user psychology index corresponding to the user situation information stored in the user information database, periodically or each time the user profile information is changed.

6. The advice recommendation system according to claim 4, wherein the user psychology index comprises a depression index, an anger index, a stress index and a mental fatigue index.

7. The advice recommendation system according to claim 5, wherein the advice providing unit comprises:
a level determination unit for determining whether or not the user psychology index calculated from the newly collected user situation information is the advice level;
an advice provision determination unit for, if the user psychology index is the advice level as a result of the determination, determining whether or not to provide the advice by transmitting an advice inquiry message to the user and receiving an advice response message from the user; and
an advice search unit for, if it is determined to provide the advice by the advice provision determination unit, searching for an advice corresponding to the newly collected user situation information from the advice database and outputting the searched advice to the user.

8. The advice recommendation system according to claim 5, wherein the advice search unit comprises:
a meta-information comparison unit for comparing meta-information or index words of advices which is stored in the advice database and matches to the determined unit advice level with the user profile information or the newly collected user situation information;
an advice extraction unit for extracting an advice including the user profile information or the newly collected user situation information as meta-information or index words from a result of the comparison;
a priority calculation unit for calculating a priority of the extracted advice in the order of an advice having meta-information or index words corresponding to the user situation information or the user profile information having a high weighting factor or in the order of the number of meta-information or index words corresponding to the user situation information or the user profile information, based on the weighting factor of the user profile information or the newly collected user situation information and the number of matched meta-information or index words; and
an advice output control unit for outputting the advice to the user according to the calculated priority of the extracted advice.

9. The advice recommendation system according to claim 5, wherein the advice search unit comprises:
a meta-information comparison unit for comparing meta-information or index words of the advice stored in the advice database and matching to the determined unit advice level with the user profile information or the newly collected user situation information;
an advice extraction unit for extracting an advice including meta-information or index words corresponding to the user profile information or the newly collected user situation information from the advice database based on a result of the comparison;
a priority calculation unit for calculating a priority of the extracted advice depending on similarity between a matching vector created from weighting factors of the user profile information and the newly collected user situation information and an advice vector created from the meta-information or the index words of the extracted advice, putting the user profile information and the newly collected user situation information on different axes; and
an advice output control unit for outputting the advice to the user according to the calculated priority of the extracted advice.

10. An advice recommendation system comprising:
a user information management unit for comparing inputted user situation information with user situation information previously stored in a user information database, and if the inputted user situation information is different from the previously stored user situation information, calculating a user psychology index corresponding to the inputted user situation information from an answer to a questionnaire inputted by a user, the inputted user situation information and the user profile information, and storing the calculated user psychology index in the user information database;
an advice determination unit for, if new user situation information is inputted, searching for a user psychology index matching to the newly inputted user situation information from the user information database and determining whether a unit advice level of the searched user psychology index corresponds to a discard level or an advice level; and
an advice providing unit for searching for an advice corresponding to the determined unit advice level, the user profile information and the newly inputted user situation information from an advice database and outputting the searched advice to the user.

11. The advice recommendation system according to claim 3, wherein the user information management unit comprises:
a comparison and determination unit for comparing the collected user situation information with the user situation information previously stored in the user information database and determining whether or not the collected user situation information is stored in the user information database;
a questionnaire providing unit for, if the collected user situation information is not stored in the user information database in advance, providing a questionnaire inquiring index factors which are obtained by converting an absolute magnitude of each user situation information item configuring the collected user situation information into a subjective magnitude that the user actually feels, and receiving an answer to the questionnaire from the user; and
a psychology index calculation unit for calculating a user psychology index corresponding to the collected user situation information through a regression model equation which defines a correlation between independent factors and dependent factors using the user situation information, the user profile information and the index factors as independent factors and using the user psychology index as a dependent factor, and storing the calculated user psychology index in the user information database.
